(19) United States
(12) Patent Application Publication
(10) Pub. No.: US 2026/0351867 A1
(43) Pub. Date: Nov. 5, 2026

(54) Connection Assembly of a First Contacting Device on a Second Contacting Device and Vehicle Having at Least One Such Connection Assembly

(71) Applicant: Bayerische Motoren Werke Aktiengesellschaft, Muenchen (DE)

(72) Inventors: Florian LETTAU, Muenchen (DE); Josef POEMMERL, Furth (DE); Wolfgang THIELE, Muenchen (DE); Markus VOCK, Garching (DE)

(21) Appl. No.: 19/117,995

(22) PCT Filed: Sep. 29, 2023
(86) PCT No.: PCT/EP2023/077033

§ 371 Date: Apr. 3, 2025

(30) Foreign Application Priority Data
Oct. 6, 2022 (DE) 10 2022 125 747.9

(51) Int. Cl. H01R 4/34; B60R 16/02; H01R 4/70; H01R 103/00

(52) U.S. Cl. CPC H01R 4/34; H01R 4/70; B60R 16/0215; H01R 2103/00; H01R 2201/26

(57) ABSTRACT

A connection assembly of a first contacting device on a second contacting device, the first and second contacting devices provided for transmitting electrical energy are electrically contacted to one another. The first contacting device includes at least two conduction elements configured separately from one another and configured to transmit the electrical energy, including a first conduction element, which is sheathed by an electrically insulating first sheathing, and a second conduction element, which is sheathed by an electrically insulating second sheathing, separate from the first sheathing. The second contacting device includes at least two conduction elements configured separately from one another and configured to transmit the electrical energy, including a third conduction element and a fourth conduction element, which are sheathed by an electrically insulating third sheathing that is configured in one piece and is common to the third conduction element and the fourth conduction element.

### BACKGROUND AND SUMMARY

The present disclosure relates to a connection assembly of a first contacting device on a second contacting device, and relates to a motor vehicle, according to independent claim(s).

DE 10 2015 216 567 A1 discloses a device known in the art for high-voltage contacting of a hybrid module. The device comprises a carrier plate with three busbars that are routed through the carrier plate. Furthermore, DE 10 2014 017 081 A1 discloses a connection assembly for the electrical contacting of a battery module. Moreover, WO 2016/062736 A1 discloses an assembly for connecting a first electrical conductor to a second electrical conductor.

The present disclosure is based on an object of creating a connection assembly, as well as a motor vehicle having a connection assembly of this kind, in such a manner that contacting devices can be mounted in a particularly simple manner and can thereby be electrically connected to one another.

This object is achieved according to the present disclosure by a connection assembly, as well as by a motor vehicle, according to the independent claim(s). Advantageous embodiments of the present disclosure are the subject matter of the dependent claims.

A first aspect of the present disclosure relates to a connection assembly of a first contacting device on a second contacting device, in particular for a motor vehicle which may also simply be referred to as a vehicle. This means that the motor vehicle, preferably configured as an automobile, in particular as a passenger car, comprises the connection assembly, and therefore the contacting devices, in its fully produced state. In the case of the connection assembly, the contacting devices are configured for transmitting electrical energy, that is, electrical current, and are therefore configured accordingly, with the contacting devices being electrically connected to one another. Consequently, for example, electrical energy can be transmitted from the first contacting device to the second contacting device and/or vice versa. In particular, the electrical energy involves a high voltage, or the electrical energy includes a high-voltage component. In other words, the contacting devices are preferably configured to transmit an electrical current at high voltage. Within the scope of the present disclosure, high voltage, and therefore the previously mentioned high voltage, should be understood to mean an electrical voltage greater than 50 volts, in particular greater than 60 volts, and preferably several hundred volts.

To enable the contacting devices to be electrically connected to one another in a particularly simple and therefore time-efficient and cost-effective manner, and consequently to enable the connection assembly to be mounted and therefore produced in a particularly time-efficient and cost-effective manner, it is proposed according to the present disclosure that the first contacting device comprises at least, or precisely, two separately constructed conductor elements configured for transmitting electrical energy, namely a first conductor element and a second conductor element. The first conductor element and the second conductor element are preferably each configured as solid bodies. In particular, the first conductor element and the second conductor element are galvanically separated from one another or electrically insulated from one another. The first conductor element is enclosed by a first electrically insulating sheath. The second conductor element is enclosed by a second sheath which is formed separately from the first sheath. The feature whereby the first sheath and the second sheath are formed separately from one another should be particularly understood to mean that the first sheath and the second sheath are not integrally formed as a single piece, that is, they are not made from a single piece, but instead the first sheath and the second sheath are constructed separately from one another. The first sheath and the second sheath are preferably each formed as solid bodies.

The second contacting device comprises at least, or precisely, two separately constructed conductor elements configured for transmitting electrical energy, namely a third conductor element and a fourth conductor element. The third conductor element and the fourth conductor element are preferably each formed as solid bodies. For example, the first conductor element is made of a first metallic material, and the second conductor element is made of a second metallic material, for example. The second metallic material and the first metallic material may be identical. For example, the first metallic material and/or the second metallic material may be aluminum or an aluminum alloy. The third conductor element is preferably made of a third metallic material and/or the fourth conductor element is made of a fourth metallic material, wherein it is conceivable that the third metallic material and the fourth metallic material are identical. It is conceivable that the third or fourth material differs from the first or second material, or that the first metallic material, the second metallic material, the third metallic material, and the fourth metallic material are identical. For example, the third and/or fourth metallic material may be copper or a copper alloy. The third conductor element and the fourth conductor element are enclosed by a third sheath which is common to the third conductor element and the fourth conductor element, is integrally formed, electrically insulating, and separately formed from the first sheath and separately formed from the second sheath. The respective sheath is preferably formed as a solid body in each case. Since each sheath electrically insulates its respective conductor element, each sheath is preferably configured as an electrical insulator in each case, meaning as a non-conductor whose electrical conductivity is preferably less than 10⁻⁸ S*cm⁻¹. In particular, it is provided that the third conductor element and the fourth conductor element are galvanically separate from one another or electrically insulated from one another, in particular by the third sheath. Furthermore, it is conceivable that the first conductor element and the second conductor element are electrically insulated from one another or galvanically separated from one another by the first sheath and by the second sheath. The feature whereby the third sheath is integrally formed should be understood to mean that the third sheath is made from a single piece, such that the third sheath is configured as a monobloc or formed by a monobloc. In particular, it is conceivable that the first conductor element is encapsulated with the first sheath, in particular directly, so that, for example, the first sheath is injection-molded, in particular directly, onto the first conductor element. Furthermore, it is conceivable that the second conductor element is encapsulated with the second sheath, in particular directly, so that, for example, the second sheath is injection-molded, in particular directly, onto the second conductor element. Additionally, it is possible that the third conductor element and the fourth conductor element are encapsulated with the third sheath, in particular directly, so that, for example, the third sheath is injection-molded, in particular directly, onto the third conductor element and the fourth conductor element. In particular, it is conceivable that each sheath is made of a respective plastics material. Most particularly, each sheath is manufactured by injection molding, in particular by plastic injection molding, so that, for example, the respective conductor element is enclosed with its corresponding sheath through the injection molding process, in particular through plastics injection molding. Expressed in other words, it is preferably provided that each sheath is molded onto the respective conductor element, in particular directly, by injection molding, in particular by plastics injection molding. It is conceivable that the first sheath itself, in other words considered independently, is integrally formed and therefore made from a single piece. Alternatively or in addition, it may be provided that the second sheath itself, in other words considered independently, is integrally formed and therefore made from a single piece.

Furthermore, it is provided according to the present disclosure that the first conductor element is electrically contacted, in other words connected, to the third conductor element, and the second conductor to the fourth conductor element, via respective recesses in the sheaths which are specifically configured as through-openings.

The respective conductor element is, for example, configured as a busbar, in particular as a high-voltage busbar. In this case, it is particularly conceivable that the respective conductor element has two wide sides that are opposite one another and two narrow sides that are opposite one another and arranged between the wide sides. Furthermore, it is conceivable that the respective conductor element has a rectangular cross section. On the one hand, the present disclosure makes it possible to handle and manipulate the third conductor element and the fourth conductor element simultaneously, particularly because the third conductor element and the fourth conductor element are encapsulated, and therefore enclosed, by the common third sheath, allowing for particularly simple and therefore time-efficient and cost-effective assembly. On the other hand, the first conductor element and the second conductor element, by being individually encapsulated and therefore enclosed by the first sheath and the second sheath, can be advantageously moved relative to one another and relative to the third conductor element and the fourth conductor element, so that tolerances, in particular, can be compensated for particularly advantageously. As a result, the connection assembly as a whole can be produced, and therefore assembled, in a particularly time-efficient and cost-effective manner. In this case, the present disclosure is based, in particular, on the following insights and considerations: In vehicles, such as electric vehicles, in particular battery-powered electric vehicles, flexible round conductors are predominantly used for wiring components in a high-voltage on-board network. However, with increasing power demands, the use of at least substantially rigid conductors, such as busbars or conductor tubes, becomes beneficial, in order to achieve a cost and space advantage in the development. However, these rigid conductor elements, which may also simply be referred to as conductors, have a technical disadvantage of limited flexibility, particularly with regard to bending. This means that the force required to shift the position of the respective conductor element, particularly relative to a given contacting interface, increases as the distance between a cable fixing point (for example, on a vehicle body or an adjacent component) and the contacting interface decreases. In addition, in the case of a flat conductor, the position of a bend must typically be taken into account, since a bending force is far lower along a long edge, so on the aforementioned wide side, than along a short edge, so on the respective aforementioned narrow side.

A contacting technology of this kind may be used as contacting technology, providing for or comprising direct contacting by, for example, a metric screw, in order to generate, for example, a required normal contact force for reliable current-carrying capacity. Depending on the requirements, for example, a galvanic noble metal coating, such as tin, silver, and/or similar materials, for example, may be used on the contact surfaces of conductor elements or contact sleeves, in order to guarantee good electrical transition resistance. For a conductor made of an aluminum alloy, a multiple detachable contact in a contact zone, according to the state of the art, requires at least one contact sleeve made of a copper alloy, as well as a galvanic precious metal coating in the contact zone. The contact sleeves may have a substance-bonded connection to the busbars, which are, for example, made of aluminum and therefore configured as aluminum busbars. Depending on the design and requirements of a respective contact point, a flat or conical or structured surface may be provided between contact points which, through an external screw, can produce an advantageous and necessary minimum contact normal force.

In a vehicle integration, it may be necessary, for assembly feasibility reasons, to separate a wiring harness in addition, so that the respective vehicle can be assembled without additional assembly work or component variations. A wiring harness with a connector at each end that includes this functional separation capability is referred to as an x-pole separation point, depending on the number of conductors. In relation to the connection assembly according to the present disclosure, it is therefore provided, for example, that the first conductor element is in electrical contact with the third conductor element at a first contact point, also referred to as the first separation point. Consequently, for example, the second conductor element is in electrical contact with the fourth conductor element at a second contact point, also referred to as the second separation point. In the connection assembly according to the present disclosure, the conductor elements are, for example, configured as at least substantially rigid busbars, wherein the present disclosure realizes a particularly advantageous assembly that can be achieved in a time-efficient and cost-effective manner. Conventional solutions typically have at least the following disadvantages:
a limited number of assembly solution options
in the case of multi-pole contacting, tolerance compensation between two halves of a separation point can only be achieved to a very limited extent, meaning that assembly is either not possible or only feasible with increased force due to positional and manufacturing tolerances, particularly since a bending force increases cubically with the busbar height
there is a potential risk of damage at the interface and to surrounding components
the use of single-pole contacting systems for a separation point in multi-pole wiring harnesses increases costs due to additional safety sensors, such as temperature sensors and HV interlock, as these must be implemented for each contact.

The aforementioned disadvantages can be avoided with the present disclosure. For example, the first conductor element and the first sheath, also referred to as the first encapsulation, form a precisely single-pole first part, and, accordingly, the second conductor element and the second sheath, also referred to as the second encapsulation, form a precisely single-pole second part. The third conductor element, the fourth conductor element, and the third sheath, also referred to as the third encapsulation, form a precisely two-pole third part, which, due to the integral design of the third sheath, can be handled as a whole, in other words as a single unit. This enables a flexible, time-efficient and cost-effective assembly process.

In a particularly advantageous embodiment of the present disclosure, the first sheath and the second sheath are mechanically connected to the third sheath via respective through-openings configured as elongated holes. The elongated holes allow for tolerance compensation, meaning compensation for, for example, production-related and/or assembly-related tolerances, particularly in that the first sheath and the second sheath can each be positioned in multiple positions that differ from one another relative to the third sheath and can be fastened to the third sheath in the respective position.

In this case, in order to facilitate particularly simple, advantageous, and therefore time-efficient and cost-effective tolerance compensation, a further embodiment of the present disclosure provides that the elongated holes are formed in the third sheath. This is specifically understood to mean the following: Since the third sheath is integrally formed, meaning it is made from a single piece, or the third piece forms or constitutes a single-piece body, which is, in particular, the previously mentioned monobloc. As a result, the through-openings pass through a section of the body. In particular, it is provided in this case that the through-openings are separate from one another. This should be taken to mean, in particular, that a wall region of the through-openings, particularly formed as a solid body, is arranged between the through-openings.

In order to allow particularly simple and therefore time-efficient and cost-effective production, and therefore assembly, of the connection assembly, while being able to compensate for tolerances in a particularly advantageous manner, another embodiment of the present disclosure provides that the respective through-openings are penetrated by respective screw elements, by which the first sheath and the second sheath are screwed to the third sheath and thereby mechanically connected to the third sheath. This is particularly understood to mean that, for example, a first of the through-openings is penetrated by, particularly precisely, a first of the screw elements, and a second of the through-openings is penetrated by, particularly precisely, a second of the screw elements. By the first screw element, for example, the first sheath is screwed to the third sheath, consequently fastened to the third sheath, as a result of which the first sheath is mechanically connected to the third sheath. By the second screw element, for example, the second sheath is screwed to the third sheath, consequently fastened to the third sheath, as a result of which the second sheath is mechanically connected to the third sheath.

In another particularly advantageous embodiment of the present disclosure, the first sheath and the second sheath are latched to the third sheath by respective latching elements. This should be particularly understood to mean that the first sheath is latched to the third sheath by first latching elements, and the second sheath is latched to the third sheath by second latching elements, as a result of which the first sheath and the second sheath are mechanically connected to the third sheath. In particular, in combination with the previously described screwing of the first sheath and the second sheath to the third sheath, the respective latching may serve as a preliminary latching, allowing the connection assembly to be produced as follows, for example: Initially, for example, the first sheath is latched to the third sheath. In addition, for example, the second sheath is initially latched to the third sheath. As a result, the first sheath and the second sheath are mechanically connected to the third sheath. So that the first sheath and the second sheath can be easily and fixedly attached to the third sheath, the first sheath and the second sheath are then screwed to the third sheath after being latched. This allows for a particularly simple and therefore time-efficient and cost-effective assembly process.

In another particularly advantageous embodiment of the present disclosure, the first conductor element is assigned a first contact sleeve, which is formed separately from the first conductor element, in particular separately from the conductor elements, and is in electrical contact, in particular directly, with the first conductor element. The second conductor element is assigned a second contact sleeve, which is formed separately from the second conductor element, in particular separately from the conductor elements, and is in electrical contact with the second conductor element. The third conductor element is assigned a third contact sleeve, which is formed separately from the third conductor element, in particular separately from the conductor elements, and is in electrical contact with the third conductor element. The fourth conductor element is assigned a fourth contact sleeve, which is formed separately from the fourth conductor element, in particular separately from the conductor elements, and is in electrical contact with the fourth conductor element. Since each contact sleeve is assigned to its respective conductor element, then conversely, each conductor element is assigned to its respective contact sleeve. In particular, it is conceivable that each contact sleeve is in direct electrical contact with its assigned conductor element. Most particularly, it is provided that the contact sleeves are configured separately from one another. It is conceivable that each contact sleeve and its respective assigned conductor element are made of materials that are different from one another, particularly metallic materials. Hence, it is conceivable that the respective contact sleeve is made of copper or a copper alloy. In this case, for example, the respective conductor element is made of aluminum or an aluminum alloy. Consequently, it is particularly conceivable that the conductor elements are made of the same material, in particular a metallic material, such as aluminum or an aluminum alloy, for example. In addition, it is conceivable for the contact sleeves to be made of the same material, in particular a metallic material, such as copper or a copper alloy, for example.

Through the recesses, the first contact sleeve is in electrical contact, particularly directly in each case, with the third contact sleeve, and the second contact sleeve with the fourth contact sleeve, as a result of which the connection assembly can be produced and assembled in a particularly simple, and therefore particularly time-efficient and cost-effective, manner.

It has been found to be particularly advantageous in this case if the third contact sleeve and the fourth contact sleeve are each assigned an electrically insulating touch protection element, which extends beyond the respective contact sleeve in the axial direction. For example, the respective touch protection element is formed separately from the third sheath and is held at least indirectly, in particular directly, on the third sheath. Since the respective touch protection element has an electrically insulating design, it is preferably an insulator, meaning an electrical non-conductor whose electrical conductivity is less than 10⁻⁸ S*cm⁻¹. This allows for a particularly high level of safety in a particularly simple manner, making it particularly easy and therefore time-efficient and cost-effective for a person to produce or assemble the connection assembly.

So that the contacting devices, in particular the conductor elements, can be connected to one another in a particularly simple and therefore particularly time-efficient and cost-effective manner, and particularly securely and fixedly, particularly electrically and mechanically, another embodiment of the present disclosure provides that the third contact sleeve is assigned a first threaded sleeve, which is formed separately from the third contact sleeve, particularly separately from the contact sleeves, and is connected, particularly directly, to the third contact sleeve, for example, by welding or soldering. The fourth contact sleeve is assigned a second threaded sleeve, which is formed separately from the fourth contact sleeve, in particular separately from the contact sleeves, and is connected, particularly directly, to the fourth contact sleeve, in particular by welding or soldering. In this case, a first screw is provided, which penetrates the first contact sleeve and is screwed into the third contact sleeve and the first threaded sleeve, which first screw is particularly provided in addition to the previously mentioned screw elements. In particular, the first screw is screwed directly into the first threaded sleeve. For this purpose, the first screw has a first external thread, for example, and the first threaded sleeve has a first internal thread, wherein the first external thread can be screwed directly into the first internal thread. By the first screw, the first contact sleeve is screwed, particularly directly, against the third contact sleeve, as a result of which the first contact sleeve and the third contact sleeve, and, consequently, the first conductor element and the third conductor element are in electrical contact with one another. Moreover, in this way, for example, the first conductor element and the third conductor element and the first contact sleeve and the third contact sleeve are mechanically connected to one another.

A second screw is also provided, particularly in addition to the screw elements and in addition to the first screw, which second screw penetrates the second contact sleeve and engages with the fourth contact sleeve and the second threaded sleeve, and is screwed into the second threaded sleeve, particularly directly. For this purpose, the second screw has a second external thread, for example, and the second threaded sleeve has a second internal thread, into which the second external thread is directly screwed, for example. By the second screw, the second contact sleeve is screwed, particularly directly, against the fourth contact sleeve, as a result of which the second contact sleeve and the fourth contact sleeve, and, in turn, the second conductor element and the fourth conductor element are in electrical contact with one another and, in particular, are mechanically connected to one another.

It has proved particularly advantageous in this case for the connection assembly to have a cover that is formed separately from the sheaths and separately from the screws and is preferably electrically insulating, meaning it is configured as a non-conductor, the cover being mechanically connected to the first sheath and/or mechanically connected to the second sheath and completely covering the screws in the axial direction of the respective screws. As a result, when the connection assembly is in a fully produced state, for example, the cover prevents unwanted direct contact between a person and the screws, for example, ensuring a particularly high degree of safety. This allows for the connection assembly to be produced in a particularly time-efficient and cost-effective manner. For example, the cover is made of a particularly electrically insulating plastic material, such as the previous plastic material, for example.

It has proved particularly advantageous in this case for the cover to be sealed against the first sheath and against the second sheath using the respective sealing elements. This ensures a particularly high degree of safety and allows the connection assembly to be produced and therefore assembled in a particularly time-efficient and cost-effective manner.

In another particularly advantageous embodiment of the present disclosure, at least, or precisely, one temperature sensor configured for detecting a temperature is embedded in the third sheath. The temperature sensor is connected to a terminal element, in particular in such a manner that an electrical signal that is provided, or can be provided, by the temperature sensor, which characterizes the temperature detected by the temperature sensor, can be transmitted from the temperature sensor to, or onto, the terminal element, which is also referred to as a terminal element. The terminal element is also referred to as the first terminal element or the first terminal element. Through the first terminal element, the electrical signal that is provided, or can be provided, by the temperature sensor and characterizes the temperature detected by the temperature sensor, can be made available. In particular, the first terminal element is a first plug-in element, also referred to as a first connector.

The temperature sensor constitutes or forms, for example, a sensor system, or is part of a sensor system, by which the connection assembly can be advantageously monitored. By embedding the temperature sensor in the third sheath, the temperature sensor is positioned within, and therefore on, the third sheath, ensuring process-reliable temperature detection and, consequently, process-reliable monitoring of the connection assembly. The temperature sensor may be configured either as a single-pole or multi-pole sensor, particularly connected in series, with a so-called interlock, for example, configured as an HV interlock (HV=high voltage), so that, for example, only a two-pole, in other words precisely a two-pole, signal line is required or provided for evaluation. The signal may, for example, be transmitted to the signal line, which is also simply referred to as a line. In particular, the signal can be transmitted to, and received by, the signal processing unit, particularly via the line and therefore via the first terminal element. Depending on the temperature, an electrical resistance, particularly the resistance value thereof, can be determined and thereby identified. In particular, the signal processing unit can unambiguously identify, by determining the temperature and therefore the resistance value, whether, for example, an interlock is open (resistance value infinite) or closed (resistance value plausible depending on the temperature) and whether the temperature sensor is operating within a plausible range. In other words, the signal processing unit enables monitoring of the connection assembly depending on the temperature.

It has proved particularly advantageous in this case if the cover has a second terminal element that corresponds to the first terminal element and is formed separately from the first terminal element, which second terminal element is configured as a second plug-in element, for example, in other words as a second connector. In this case, the first terminal element and the second terminal element are particularly configured to be detachable in a non-destructive manner, are plugged into one another, and are thereby in electrical contact with one another, and preferably also mechanically connected to one another, as a result of which the signal can be transmitted from the first terminal element to the second terminal element. Consequently, a particularly high degree of safety can be achieved in a particularly simple manner, particularly by designing the cover—also referred to as a service cover—in such a manner that it can only be fixed, or is fixed, to the first sheath and/or to the second sheath, and contacting, also referred to as signal contacting, of the first terminal element via the previously mentioned line, for example, is only possible when the cover is connected to the first sheath and/or the second sheath, and during this, or as a result of this, the second terminal element is in electrical contact with the first terminal element.

It has also proved particularly advantageous in this case if a third terminal element is provided, which is formed separately from the first terminal element and separately from the second terminal element and which is also referred to as the third connector or third plug-in element. The second terminal element and the third terminal element in this case are particularly configured to be detachable in a non-destructive manner, are plugged into one another, and are thereby in electrical contact with one another, and preferably mechanically connected to one another, as a result of which the signal can be transmitted from the second terminal element to the third terminal element. For example, the third terminal element is part of the previously mentioned line. For example, the third terminal element cannot be in direct electrical contact with the first terminal element; rather, the third terminal element can only be brought into electrical contact with the first terminal element with the assistance of the second terminal element, so that, for example, the third terminal element can only be in indirect electrical contact with the first terminal element when the second terminal element is installed and is thereby in electrical contact with the first terminal element. In this case, the third terminal element can only brought into electrical contact with the first terminal element with the assistance of the second terminal element, ensuring that the line can only be installed when the cover is mounted. In this way, a particularly high degree of safety can be guaranteed in a simple manner.

Finally, it has proved particularly advantageous if the first sheath and the second sheath are sealed against the third sheath using respective sealing elements, thereby achieving a particularly high degree of safety in a particularly simple and cost-effective manner.

A second aspect of the present disclosure relates to a motor vehicle, which may also simply be referred to as a vehicle, and is preferably configured as an automobile, in particular as a passenger car. The motor vehicle according to the second aspect of the present disclosure comprises at least one connection assembly according to the first aspect of the present disclosure. Advantages and advantageous embodiments of the first aspect of the present disclosure are to be regarded as advantages and advantageous embodiments of the second aspect of the present disclosure, and vice versa.

Further details of the present disclosure emerge from the following description of a preferred embodiment, accompanied by the corresponding drawings.

### BRIEF DESCRIPTION OF THE DRAWINGS

FIG. 1: shows a schematic representation of two components of a motor vehicle, wherein the components are electrically connected to one another by a connection assembly;

FIG. 2: shows a schematic and sectional side view of the connection assembly;

FIG. 3: shows a schematic plan view of the connection assembly;

FIG. 4: shows a schematic perspective view of the connection assembly;

FIG. 5: shows a detail of another schematic plan view of the connection assembly;

FIG. 6: shows a detail of another schematic perspective view of the connection assembly;

FIG. 7: shows a schematic perspective view of a third sheath of the connection assembly;

FIG. 8: shows a detail of another schematic sectional view of the connection assembly;

FIG. 9: shows a schematic and perspective bottom view of a cover of the connection assembly;

FIG. 10: shows a detail of a schematic and perspective plan view of the connection assembly;

FIG. 11: shows a detail of a schematic perspective view of conductor elements of the connection assembly; and

FIG. 12: shows a detail of another schematic perspective view of the connection assembly.

### DETAILED DESCRIPTION OF THE DRAWINGS

In the figures, identical or functionally equivalent elements are labeled using the same reference signs.

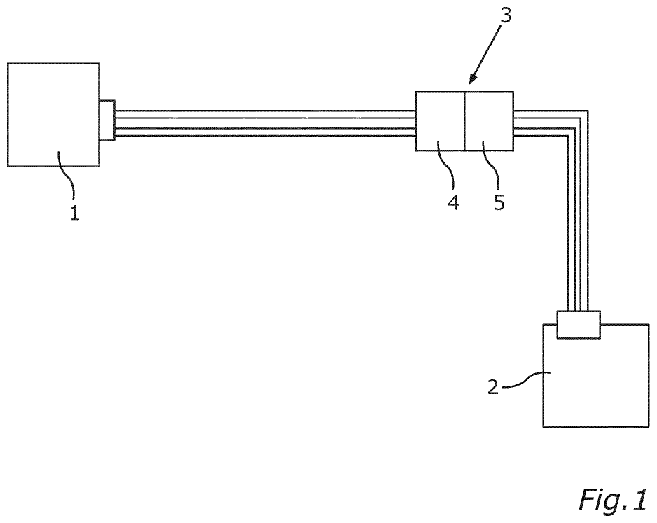

FIG. 1 provides a schematic representation of two components, 1 and 2, of a motor vehicle, also referred to as a vehicle, which is preferably configured as an automobile, in particular as a passenger car, and which, in its fully produced state, includes components 1 and 2. The components 1 and 2 are electrically connected to one another via a connection assembly 3 which is particularly schematically illustrated in FIG. 1, so that, for example, electrical energy can be transferred via the connection assembly 3 from one of the components 1, 2 to the other component 2, 1, and/or vice versa. The transfer of electrical energy should be particularly understood to mean that an electric current is transmitted at an electrical voltage. Most preferably, the electrical voltage is a high voltage, also referred to as high-voltage potential, meaning that the electrical voltage is preferably greater than 50 volts, in particular greater than 60 volts, and most preferably several hundred volts. Consequently, the connection assembly 3 is particularly configured to transmit electrical currents at an electrical voltage greater than 50 volts, in particular greater than 60 volts, and most preferably several hundred volts. For example, one of the components 1, 2 is configured as an electric machine by which the vehicle can be driven, particularly entirely, electrically. The other component 2, 1 is, for example, configured as an electrical energy storage device, specifically a battery, in particular a high-voltage battery. The electric machine and the electrical energy storage device are preferably high-voltage components, each with an electrical voltage, in particular an electrical operating and nominal voltage, preferably greater than 50 volts, particularly greater than 60 volts, and most preferably several hundred volts.

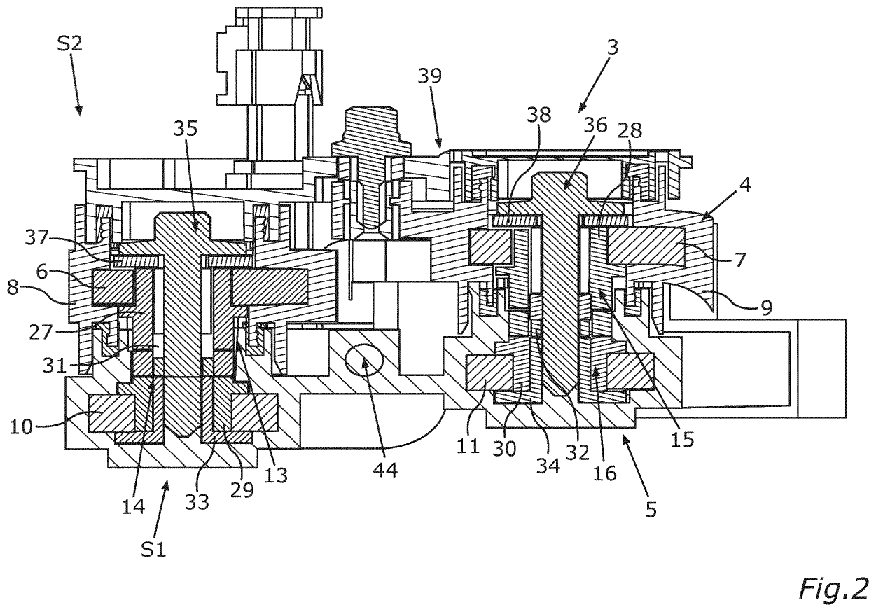

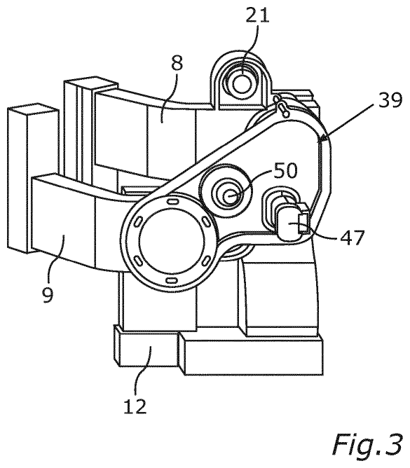

As can be seen particularly clearly from FIG. 2, the connection assembly 3 has a first contacting device 4 arranged on a second contacting device 5 in such a manner that the contacting devices 4 and 5, which are provided and therefore configured to transmit electrical energy, are in electrical contact with one another. The first contacting device 4 has two conductor elements which are formed separately from one another and configured to transmit electrical energy, namely a first conductor element 6 and a second conductor element 7. In the embodiment shown in the figures, the conductor elements 6 and 7 are configured as busbars. Each conductor element 6, 7 is formed as a solid body. The respective conductor element 6, 7 is made of a metallic material, in this case aluminum, specifically an aluminum alloy. In particular, the conductor elements 6 and 7 are galvanically separated from one another or are electrically insulated from one another. As can be seen particularly clearly in conjunction with FIG. 3, the first conductor element 6 is enclosed, particularly directly, by an electrically insulating first sheath 8. Moreover, the second conductor element 7 is enclosed, in particular directly, by an electrically insulating second sheath 9, which is formed separately from the first sheath 8. The sheaths 8 and 9 are also referred to as encapsulations. It is evident that the conductor elements 6 and 7 are individually surrounded by their respective sheaths 8, 9, in particular in such a manner that the sheath 8 is injection-molded, in particular directly, onto the conductor element 6, and the sheath 9 is injection-molded, in particular directly, onto the conductor element 7.

The second contacting device 5 comprises two separately constructed conductor elements configured for transmitting electrical energy, namely a third conductor element 10 and a fourth conductor element 11. The conductor elements 10 and 11 are configured as busbars in the present case. The conductor elements 10 and 11 are configured as solid bodies in the present case. The conductor elements 10 and 11 are galvanically separate from one another, for example, meaning, in particular, that they are electrically insulated from one another. For example, the respective conductor element 10, 11 is made of a metallic material, in particular aluminum, and most particularly an aluminum alloy. The conductor elements 6, 7, 10, and 11 are preferably made of the same metallic material, in particular the same aluminum alloy. As can be seen particularly clearly in conjunction with FIG. 3, the conductor elements 10 and 11 are enclosed, in particular directly, by a third sheath 12 which is common to the conductor elements 10 and 11, is integrally formed, electrically insulating, and which is also referred to as the third encapsulation. The third sheath 12 is formed separately from the first sheath 8 and separately from the second sheath 9. In particular, the respective sheath 8, 9, and 12 is configured as a solid body. Most particularly, the respective sheath 8, 9, and 12 is made of plastic. For example, the sheath 12 is injection-molded, particularly directly, onto the conductor elements 10 and 11.

It can be seen from FIG. 2 that the first conductor element 6 is in electrical contact with the third conductor element 10, and the second conductor element 7 is in electrical contact with the fourth conductor element 11 through respective recesses 13, 14, 15, and 16 in the sheaths 8, 9, and 12, which are configured as through-openings. In this case, the recess 13 is a first recess in the sheath 8, the recess 15 is a second recess in the sheath 9, and the recess 14 is a third recess in the sheath 12, and the recess 16 is a fourth recess in the sheath 12.

As can be seen from FIG. 5, the first sheath 8 has a first elongated hole 17 configured as a through-opening. The sheath 9 has a second elongated hole 18 configured as a through-opening. The elongated hole 17 is arranged to overlap with a corresponding first screw opening 19, while the elongated hole 18 is arranged to overlap with a corresponding second screw opening 20. The screw openings 19 and 20 are arranged, in other words formed, in the third sheath 12, wherein, for example, each screw opening 19, 20 can be configured as a through-opening. It can be seen from FIG. 10 that the elongated hole 17 and screw opening 19 are assigned a first screw element 21 configured as a screw, which penetrates the elongated hole 17 and is screwed into the screw opening 19. The elongated hole 18 and associated screw opening 20 are assigned a second screw element 22, which penetrates the elongated hole 18 and is screwed into screw opening 20. As a result, the first sheath 8 is screwed to the third sheath 12 by the screw element 21 and thereby mechanically connected to the third sheath 12. The sheath 9 is connected to the sheath 12 by the screw element 22 and thereby mechanically connected to the sheath 12. It is evident that the sheaths 8 and 9 are screwed to the sheath 12 by the screw elements 21 and 22, and are thereby mechanically connected to the sheath 12. It is conceivable in this case for a respective thread, in particular configured as an internal thread, to be arranged in the respective screw opening 19, 20, in particular in such a manner that the respective thread arranged in the respective screw opening 19, 20 is formed by a threaded insert, in particular a metallic one, which is, for example, embedded in the sheath 12. The elongated holes 17 and 18 in this case allow for particularly advantageous, in particular translational and/or rotational, tolerance compensation between the respective sheath 8, 9 and the sheath 12.

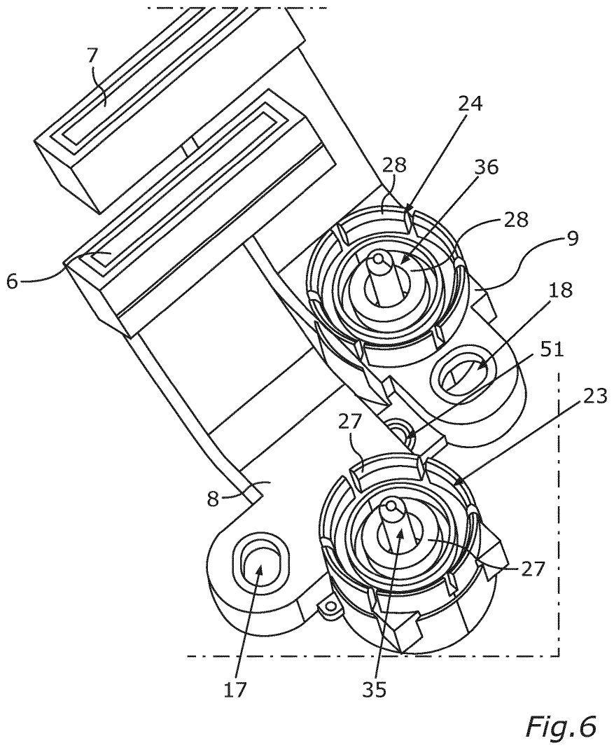

Furthermore, a latching mechanism, particularly configured as a pre-latching mechanism, for securing the respective sheath 8, 9 to the sheath 12 is provided in the connection assembly 3. As can be seen from FIGS. 6, 7, and 8, the respective sheath 8, 9 has at least one respective latching element 23, 24 for this purpose, which is latched with a corresponding latching element 25, 26 on the third sheath 12 in each case. This allows for secure handling during an assembly process in which the connection assembly 3 is produced and assembled, for example for a person manufacturing and assembling the connection assembly 3. For example, each latching element 23, 24 and/or its respective corresponding latching element 25, 26 has a respective insertion slope 27, 28, which enables the latching elements 23 and 25 or 24 and 26 to be latched to one another particularly easily and advantageously.

As can be seen from FIG. 2, the first conductor element 6 is assigned a first contact sleeve 27, which is formed separately from the conductor elements 6, 7, 10, and 11 and is electrically connected to the first conductor element 6, in particular directly. The second conductor element 7 is assigned a second contact sleeve 28, which is formed separately from the conductor elements 6, 7, 10, and 11 and is in electrical contact, in particular directly, with the conductor element 7. The third conductor element 10 is assigned a third contact sleeve 29, which is configured separately from the conductor elements 6, 7, 10, and 11 and is in electrical contact, in particular directly, with the conductor element 10. The fourth conductor element 11 is assigned a fourth contact sleeve 30, which is formed separately from the conductor elements 6, 7, 10, and 11 and is in electrical contact with the conductor element 11, in particular directly. The contact sleeves 27, 28, 29, and 30 are formed separately from one another. In particular, the contact sleeves 27, 28, 29 and 30 are made of the same material, in particular a metallic material, in particular copper or a copper alloy. The contact sleeves 27 and 29 are in electrical contact with one another, in particular directly, in such a manner that the respective end faces of the contact sleeves 27 and 29 are directly supported against one another in the axial direction of the respective contact sleeve 27, 29. The contact sleeves 28 and 30 are in electrical contact with one another, such that respective end faces of the contact sleeves 28 and 30 are directly supported against one another in the axial direction of the respective contact sleeve 28, 30. Consequently, the conductor elements 6 and 10 are in electrical contact with one another via the contact sleeves 27 and 29, and the conductor elements 7 and 11 are in electrical contact with one another via the contact sleeves 28 and 30.

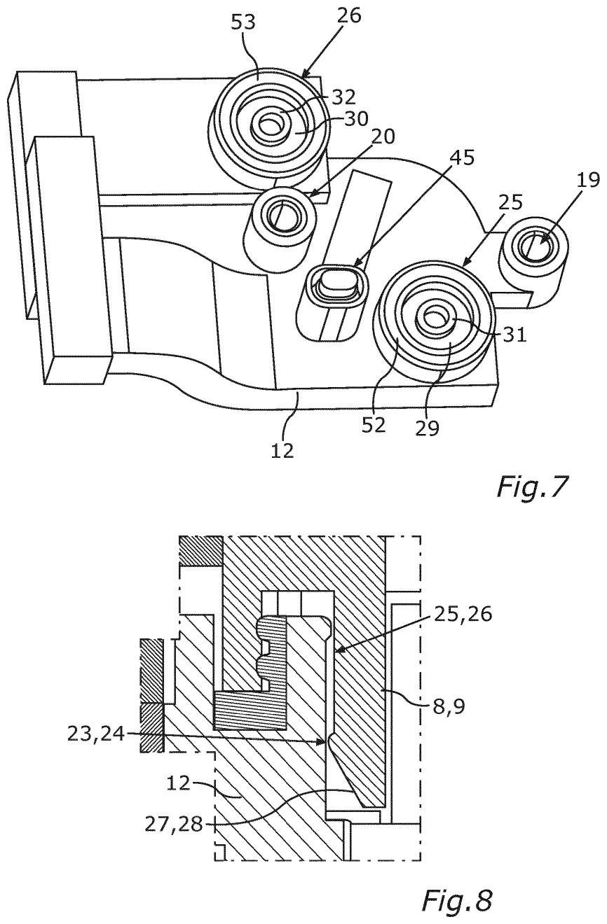

It can be seen particularly clearly from FIG. 7 that the contact sleeve 29 is assigned a first touch protection element 31, and the contact sleeve 30 is assigned a second touch protection element 32. Each touch protection element 31, 32 extends beyond the contact sleeve 29, 30 assigned in each case in the axial direction of the respective contact sleeve 29, 30, thereby providing particularly advantageous touch protection. In particular, the respective touch protection element 31, 32 is electrically insulating and, in particular, made of an electrically insulating plastic in this case. As can be seen in FIG. 2, the first touch protection element 31 engages with the contact sleeve 27, and the touch protection element 32 engages with the contact sleeve 28.

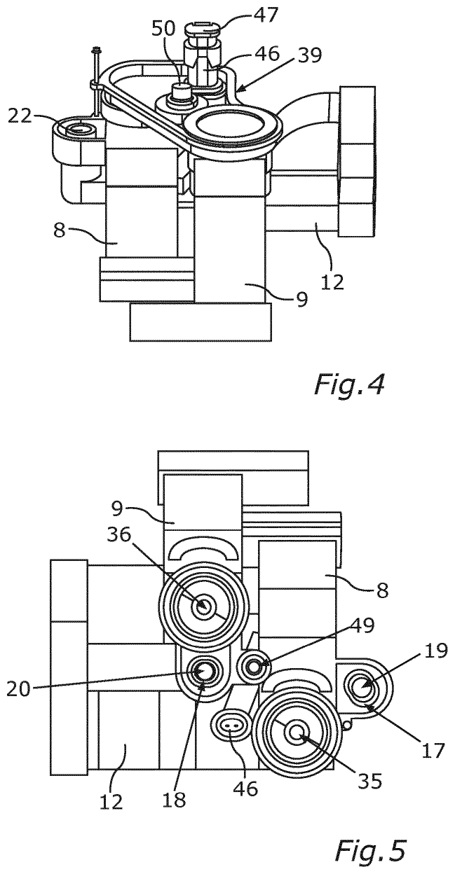

The third contact sleeve 29 is assigned a first threaded sleeve 33 which engages with the contact sleeve 29. Likewise, the fourth contact sleeve 30 is assigned a second threaded sleeve 34 which engages with the contact sleeve 30. The threaded sleeves 33 and 34 are formed separately from one another and separately from the contact sleeves 27, 28, 29, and 30. In this case, the threaded sleeve 33 is connected to the contact sleeve 29, in particularly directly, and the threaded sleeve 34 is connected to the contact sleeve 30, in particularly directly. A first screw 35 is provided, which passes through the first contact sleeve 27 and engages with the contact sleeve 29 and with the threaded sleeve 33, and is screwed directly into the threaded sleeve 33, by which first screw the first contact sleeve 27 is screwed against the third contact sleeve 29, in particularly directly, as a result of which the first contact sleeve 27 and the third contact sleeve 29, and, moreover, the first conductor element 6 and the third conductor element 10, are in electrical contact with one another. A second screw 36 is also provided, which passes through the second contact sleeve 28 and engages with the threaded sleeve 34 and the contact sleeve 30, and is screwed directly into the threaded sleeve 34, by which second screw 36 the second contact sleeve 28 is screwed, in particular directly, against the fourth contact sleeve 30. As a result of this, an electrical contact is established between the second contact sleeve 28 and the fourth contact sleeve 30, and, moreover, between the second conductor element 7 and the fourth conductor element 11. Each screw 35, 36 is supported by its respective screw head and, in this case, by an optionally provided washer 37, 38, particularly in the axial direction of the respective screw 35, 36, against the respective contact sleeve 27, 28 and/or against the respective conductor element 6, 7. On a first side S1 of the sheath 12, which faces away from the conductor elements 6 and 7 and from the sheaths 8 and 9, the screws 35 and 36, along with the contact sleeves 29 and 30, and the threaded sleeves 33 and 34, and also the conductor elements 10 and 11, are completely covered and thereby shielded and, in particular, electrically insulated, by the sheath 12. On a respective second side S2 of the respective enclosure 8, 9, which faces away or is turned away from the sheath 12, the following is provided: On the respective second side S2 of the respective sheath 8, 9, a cover 39, also referred to as a service cover, is provided, which can be seen particularly clearly seen from FIGS. 3 and 4. The cover 39 is formed separately from the sheaths 8, 9, and 12, separately from the screws 35 and 36, and also separately from the screw elements 21 and 22, wherein it is provided in this case that the screws 36 and 35 are provided in addition to the screw elements 21 and 22. By the cover 39, the screws 35 and 36 on the respective second side S2 are completely covered and thereby shielded and electrically insulated, wherein the cover 39 on the respective side S2 also covers, for example, the washers 37 and 38 and/or the conductor elements 6 and 7, in particular completely. In particular, the cover 39 is an electrically insulating cover and is made of an electrically insulating material, in particular plastic, in this case.

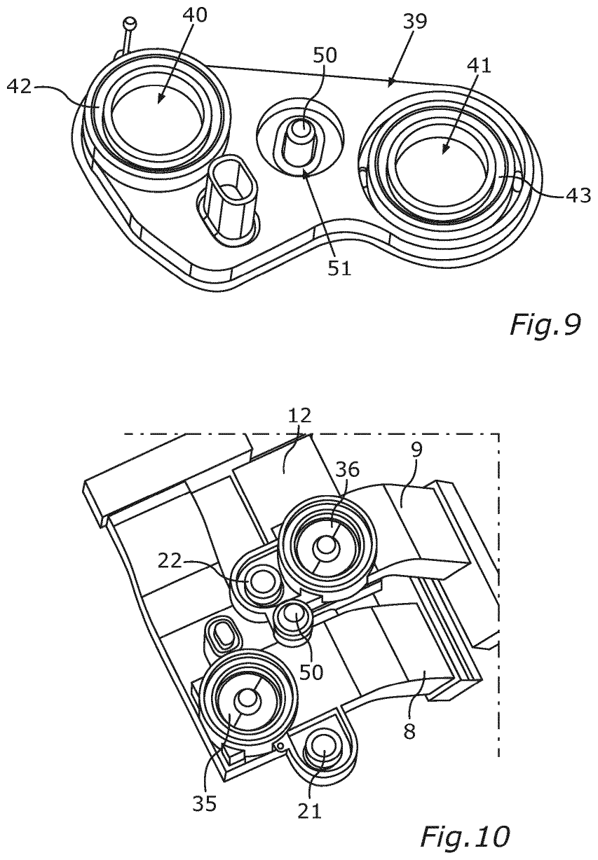

As can be seen in FIG. 9, the cover 39 has recesses 40 and 41, wherein the screw 35, in particular its screw head, is at least partially received in the recess 40, and the screw 36, in particular its screw head, is at least partially received in recess 41. Each recess 40, 41 is completely surrounded along its circumferential direction by a respective sealing element 42, 43, wherein the cover 39 is sealed against the respective sheath 8, 9 by the sealing elements 42 and 43, in particular in such a manner that the cover 39 is sealed against the sheath 8 by the sealing element 42 and against sheath 9 by the sealing element 43.

As can be seen in FIGS. 2 and 11, at least one, or exactly one, temperature sensor 44 is embedded in the third sheath 12, by which a temperature can be detected. The temperature sensor 44 can generate an electrical signal that characterizes, that is, describes, the temperature detected by the temperature sensor 44. The temperature sensor 44 is in electrical contact with, that is, connected to, a first terminal element 45 which first terminal element 45 is held in place on the third sheath 12, in particular at least partially embedded in the sheath 12. The first terminal element 45 can provide the signal, so that the signal from the temperature sensor 44 can be to be made available via the terminal element 45. The signal can, for example, be received by a signal processing unit, so that the signal processing unit can monitor the connection assembly 3 depending on the signal.

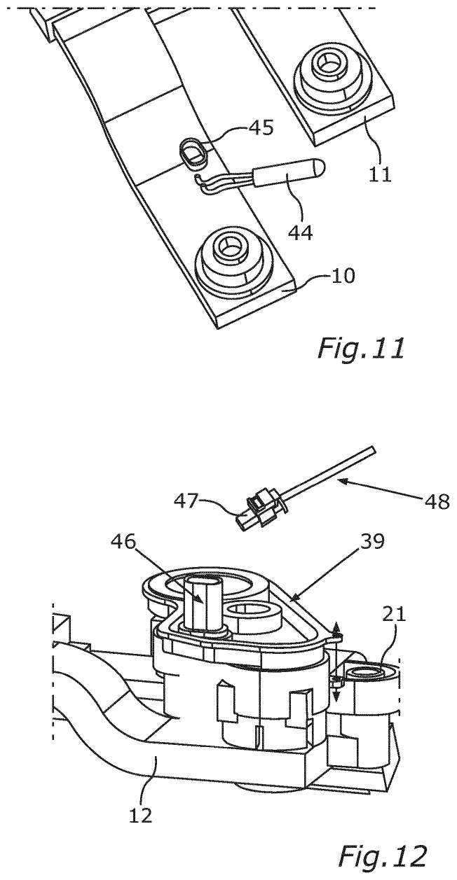

As can be seen from FIG. 12, the cover 39 has a second terminal element 46, which corresponds to the first terminal element 45 and is formed separately from the terminal element 45, wherein the first terminal element 45 and the second terminal element 46 are plugged into one another, in particular in a non-destructive detachable manner, and thereby have an electrical contact with one another. In this way, the signal from the terminal element 45 can be transmitted to the terminal element 46 and supplied by the terminal element 46. A third terminal element 47, which can be seen in FIG. 12 and is formed separately from the terminal element 45 and separately from the terminal element 46, is also provided. The terminal element 47 is also part of a line 48, referred to as a signal line, via which the signal can be transmitted, in particular from the terminal element 46 to the signal processing unit. Hence, the signal processing unit can receive the signal via signal line 48. In the fully assembled state of the connection assembly 3, the second terminal element 46 and the third terminal element 47 are plugged into one another and are thereby in electrical contact with one another, as a result of which the signal can be transmitted from the second terminal element 46 to the third terminal element 47. In this case, for example, the terminal elements 45 and 46 are plugged into one another in such a manner that the terminal element 46 is plugged into the terminal element 45. The terminal elements 46 and 47 are, for example, plugged together in such a manner that the terminal element 47 is plugged into the terminal element 46, or vice versa. Consequently, the terminal elements 45, 46, and 47 are connectors. With reference to the terminal elements 45, 46, and 47, the terminal element 47 cannot be in electrical contact with the terminal element 45 without the terminal element 46, so that the terminal element 47 can only be in electrical contact with the terminal element 45 with the assistance of the terminal element 46. In this way, a particularly secure installation of the connection assembly 3 can be ensured. The respective screw 35, 36 is preferably an M6 screw and/or is touch-protected. In particular, the terminal element 47 is a communication connector, via which the signal can be transmitted to the signal processing unit. The cover 39 is held on the sheath 8 by screws. For this purpose, the sheath 8, as can be seen from FIG. 5, has a screw opening 49, which is formed, for example, as a through-opening. A second thread, particularly configured as an internal thread, is arranged in the screw opening 49, wherein the second thread is, for example, formed by a threaded insert, which is embedded in the enclosure 8, for example. The screw opening 49 is assigned a screw element 50 configured as an additional screw in the present case (FIG. 10). The screw element 50 passes through a corresponding through-opening 51 in the cover 39, which can be seen from FIG. 9, and is screwed into the corresponding screw opening 49, thereby fastening it to the sheath 8. In this way, the cover 39 is screwed to the sheath 8 and thereby held on the sheath 8 and also on the sheath 9.

It can be seen particularly clearly from FIG. 6 that the elongated holes 17 and 18 in the sheaths 8 and 9 are configured as through-openings.

It can be seen from FIG. 7 that the sheath 12 is sealed against the sheath 8 by a sealing element 52 and against the sheath 9 by a sealing element 53. In the present case, the sealing element 52 runs completely around the contact sleeve 29 in the circumferential direction of the contact sleeve 29, and the sealing element 53 runs completely around the contact sleeve 30 in the circumferential direction of the contact sleeve 30.

The arrangement of the cover 39 on the sheaths 8 and 9 can be seen particularly clearly visible from FIG. 7. It can be seen from FIG. 5 that the elongated holes 17 and 18 allow for rotational tolerance compensation of up to ±3 degrees between the respective sheaths 8, 9 and the sheath 12. In addition, by the sealing elements 52 and 53, a particularly advantageous radial and axial seal can be realized. Furthermore, defined water drainage holes can be provided, through which water can be prevented from creeping under the sealing elements 52 and 53. These water drainage holes are arranged between the locking parts of the respective latching elements 23, 24 in the present case, in particular viewed in the circumferential direction of the respective screw 35, 36. In particular, it is conceivable for the respective sealing element 52, 53, particularly when viewed in its respective cross-section, to have an L-shaped design and/or at least, or exactly, two lamellae, so that a particularly advantageous radial and axial sealing effect can thereby be achieved. The same can be applied to the respective sealing element 42, 43 on, or in, the cover 39. Hence, for example, the respective sealing element 42, 43, particularly when viewed in its respective cross-section, is L-shaped and/or the respective sealing element 42, 43 has at least, or exactly, two lamellae, so that a particularly advantageous radial and axial sealing effect can be achieved. In particular, the latching parts create a segmented retaining collar, which is segmented in the circumferential direction of the respective screw 35, 36, in such a manner that in the circumferential direction of the respective screw 35, 36, the respective water drainage opening is arranged between the respective latching parts, in particular as the respective through-opening.

In particular, it is possible to attach the conductor elements 6 and 7 to the conductor elements 10 and 11 independently of one another and, in particular, sequentially. First, for example, the respective sheath 8, 9 is latched with the sheath 12 and thereby pre-latched. Subsequently, the respective sheath 8, 9 is screwed to the sheath 12, in particular pre-screwed, and in particular by the screw elements 21 and 22. Following this, an electrical screw connection is made, for example, in such a manner that the screws 35 and 36 are screwed and, in particular, tightened or fully tightened. As a result of this, the conductor element 6 is in electrical contact with the conductor element 10, and the conductor element 7 is in electrical contact with the conductor element 11, and the conductor elements 6 and 7 are also attached mechanically and fixedly to the conductor elements 10 and 11. This is followed by the mounting of the cover 39, which, as described, is screwed to the enclosure 12, in particular by the screw element 50. In this way, a decoupling of the mechanical and electrical connections can be achieved, in particular by an additional mechanical screw connection, that is, a mechanical screw connection provided in addition to the electrical screw connection, which mechanical screw connection is configured as a mechanical pre-screw connection and can be realized by the screw elements 21 and 22. The respective screws can be mounted in a captive manner in this case.

The temperature sensor 44 is, for example, a PTC element, which is encapsulated within the sheath 12, in particular by overmolding. In particular, the line 48 is a conductor of an on-board network, so that the first terminal element 45 can be electrically connected to the on-board network via the terminal elements 46 and 47. In particular, the terminal element 46 comprises a pin housing, in particular with an integrated stamped grid on both sides. The terminal element 47, which is configured, for example, as an on-board network connector, cannot be plugged directly into or onto the terminal element 45, but must be in electrical contact with the terminal element 45 with the assistance of the terminal element 46. In this way, protection against incorrect connection can be guaranteed. In particular, the following advantages can be achieved:
simplified assembly in a vehicle manufacturing plant and during service
new routing options possible for wiring harnesses during development
cost savings due to minimal signal processing at multi-pole separation points and the evaluation electronics thereof
lower static failure rates through a reduction in connector plug systems.

List of reference signs

| | |
|---|---|
| 1 | Component |
| 2 | Component |
| 3 | Connection assembly |
| 4 | Contacting device |
| 5 | Contacting device |
| 6 | Conductor element |
| 7 | Conductor element |
| 8 | Sheath |
| 9 | Sheath |
| 10 | Conductor element |
| 11 | Conductor element |
| 12 | Sheath |
| 13 | Opening |
| 14 | Opening |
| 15 | Opening |
| 16 | Opening |
| 17 | Elongated hole |
| 18 | Elongated hole |
| 19 | Screw opening |
| 20 | Screw opening |
| 21 | Screw element |
| 22 | Screw element |
| 23 | Latching element |
| 24 | Latching element |
| 25 | Latching element |
| 26 | Latching element |
| 27 | Contact sleeve |
| 28 | Contact sleeve |
| 29 | Contact sleeve |
| 30 | Contact sleeve |
| 31 | Touch protection element |
| 32 | Touch protection element |
| 33 | Threaded sleeve |
| 34 | Threaded sleeve |
| 35 | Screw |
| 36 | Screw |
| 37 | Washer |
| 38 | Washer |
| 39 | Cover |
| 40 | Recess |
| 41 | Recess |
| 42 | Sealing element |
| 43 | Sealing element |
| 44 | Temperature sensor |
| 45 | Terminal element |
| 46 | Terminal element |
| 47 | Terminal element |
| 48 | Line |
| 49 | Screw opening |
| 50 | Screw |
| 51 | Through-opening |
| S1 | Side |
| S2 | Side |

1.-15. (canceled)

16. A connection assembly of a first contacting device on a second contacting device, wherein the first and second contacting devices provided to transmit electrical energy are in electrical contact with one another,
wherein the first contacting device comprises at least two separately formed conductor elements configured for transmitting electrical energy, wherein the at least two separately formed conductor elements comprise:
a first conductor element, which is enclosed by a first electrically insulating sheath; and
a second conductor element, which is enclosed by a second electrically insulating sheath which is separately formed from the first sheath;
wherein the second contacting device comprises at least two separately formed conductor elements configured for transmitting electrical energy, wherein the at least two separately formed conductor elements comprise a third conductor element and a fourth conductor element, which are enclosed by a third sheath which is common to the third conductor element and the fourth conductor element, is integrally formed, and electrically insulating;
and
wherein the first conductor element is in electrical contact with the third conductor element and the second conductor element is in electrical contact with the fourth conductor element through respective recesses in the first, second, and third sheaths.

17. The connection assembly according to claim 16,
wherein the first sheath and the second sheath are connected to the third sheath via respective through-openings configured as elongated holes.

18. The connection assembly according to claim 17,
wherein the elongated holes are formed in the third sheath.

19. The connection assembly according to claim 17,
wherein the respective elongated holes are penetrated by respective screw elements, through which the first sheath and the second sheath are screwed to the third sheath.

20. The connection assembly according to claim 16,
wherein the first sheath and the second sheath are latched to the third sheath by respective latching elements.

21. The connection assembly according to claim 16, further comprising:
a first contact sleeve assigned to the first conductor element, wherein the first contact sleeve is formed separately from the first conductor element and is in electrical contact with the first conductor element;
a second contact sleeve assigned to the second conductor element, wherein the second contact sleeve is separately formed from the second conductor element and is in electrical contact with the second conductor element;
a third contact sleeve assigned to the third conductor element, wherein the third contact sleeve is separately formed from the third conductor element and is in electrical contact with the third conductor element; and
a fourth contact sleeve assigned to the fourth conductor element, wherein the fourth contact sleeve is separately formed from the fourth conductor element and is in electrical contact with the fourth conductor element,
wherein the first contact sleeve is in electrical contact with the third contact sleeve, and the second contact sleeve is in electrical contact with the fourth contact sleeve, via the recesses.

22. The connection assembly according to claim 21,
wherein the third contact sleeve and the fourth contact sleeve are each assigned an electrically insulating touch protection element, which extends beyond the respective third and fourth contact sleeves, assigned to the respective touch protection element, in an axial direction of the respective third and fourth contact sleeves.

23. The connection assembly according to claim 21, further comprising:
a first threaded sleeve assigned to the third contact sleeve, wherein the first threaded sleeve is formed separately from the third contact sleeve and is connected to the third contact sleeve;
a second threaded sleeve assigned to the fourth contact sleeve, wherein the second threaded sleeve is formed separately from the fourth contact sleeve and is connected to the fourth contact sleeve;
a first screw, which penetrates the first contact sleeve and engages with the third contact sleeve and the first threaded sleeve, and is screwed into the first threaded sleeve, wherein by the first screw the first contact sleeve is screwed against the third contact sleeve, as a result of which the first contact sleeve and the third contact sleeve and, consequently, the first conductor element and the third conductor element are in electrical contact with one another; and
a second screw, which penetrates the second contact sleeve and engages with the fourth contact sleeve and the second threaded sleeve, and is screwed into the second threaded sleeve, wherein by the second screw the second contact sleeve is screwed against the fourth contact sleeve, as a result of which the second contact sleeve and the fourth contact sleeve and, consequently, the second conductor element and the fourth conductor element are in electrical contact with one another.

24. The connection assembly according to claim 23, further comprising:
a cover, which is formed separately from the first, second, and third sheaths and separately from the first and second screws, which is mechanically connected to the first sheath and/or the second sheath, and completely covers the first and second screws in an axial direction of the respective first and second screws.

25. The connection assembly according to claim 24,
wherein the cover is sealed against the first sheath and against the second sheath by respective sealing elements.

26. The connection assembly according to claim 16, further comprising:
at least one temperature sensor configured for detecting a temperature embedded in the third sheath, wherein the at least one temperature sensor is connected to a terminal element, through which an electrical signal that can be supplied by the at least one temperature sensor and characterizes the temperature detected by the at least one temperature sensor can be supplied.

27. The connection assembly according to claim 24, further comprising: at least one temperature sensor configured for detecting a temperature embedded in the third sheath, wherein the at least one temperature sensor is connected to a terminal element, through which an electrical signal that can be supplied by the at least one temperature sensor and characterizes the temperature detected by the at least one temperature sensor can be supplied, and
wherein the cover has a second terminal element that corresponds to the first terminal element and is formed separately from the first terminal element, and the first terminal element and the second terminal element are plugged into one another, and are thereby in electrical contact with one another, as a result of which the electrical signal can be transmitted from the first terminal element to the second terminal element.

28. The connection assembly according to claim 27, further comprising:
a third terminal element, which is formed separately from the first terminal element and the second terminal element, wherein the second terminal element and the third terminal element are plugged into one another, and are thereby in electrical contact with one another, as a result of which the electrical signal can be transmitted from the second terminal element to the third terminal element.

29. The connection assembly according to claim 16,
wherein the first sheath and the second sheath are sealed against the third sheath by respective sealing elements.

30. A motor vehicle comprising at least one connection assembly according to claim 16.
